(19) United States
(12) Patent Application Publication
(10) Pub. No.: US 2005/0137997 A1
(43) Pub. Date: Jun. 23, 2005

(54) Method for updating an automation system

(75) Inventors: Jurgen Bussert, Igensdorf (DE); Harald Herberth, Oberasbach (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 11/009,517

(22) Filed: Dec. 10, 2004

(30) Foreign Application Priority Data
Dec. 11, 2003 (DE) 10358019.0

(51) Int. Cl. G06F 7/00

(52) U.S. Cl. 707/1

(57) ABSTRACT

An automation system with a data processing device and an automation device connected to a network, with the automation device including a network server, a current operating system and an application program running under the current operating system, can be updated by transmitting a new operating system to the automation device via the network. The network can be the Internet and/or an intranet.

### CROSS-REFERENCES TO RELATED APPLICATIONS

This application claims the priority of German Patent Application, Serial No. 103 58 019.0, filed Dec. 11, 2003, pursuant to 35 U.S.C. 119(a)-(d).

### BACKGROUND OF THE INVENTION

The present invention relates to a method for updating an automation system, in particular to a method for updating firmware of an automation system via a network.

Nothing in the following discussion of the state of the art is to be construed as an admission of prior art.

Automation devices are used, for example, in manufacturing and processing facilities, and increasingly include features that allow remote data transmission via a communication network, in particular, via the Internet or via an intranet. Remote data transmission can not only be used to read data, but also to mediate control processes performed by the automation device which, however, typically does not change the operating system of the automation device, also referred to as firmware. The operating system or firmware of the automation device can be updated by loading a new version of the operating system at the site where the system is located. Because the automation device itself typically has limited operator control, the portable storage medium of the automation device must in general be removed while the device is turned off, with new firmware then being loaded at another suitable location. After the updated storage medium has been placed in the automation device, the automation device is turned on again. Prior art installations were unable to use the remote data link for this purpose.

It would therefore be desirable and advantageous to provide an improved method for updating an automation system, which obviates prior art shortcomings and is able to specifically remotely update firmware of automation devices.

### SUMMARY OF THE INVENTION

According to an aspect of the invention, a method for updating an automation system with a data processing device and an automation device, which includes a network server, a current operating system and an application program running under the current operating system, includes the steps of connecting the data processing device with the automation device via a network, and transmitting a new operating system to the automation device via the network.

The automation device also includes a network server and an application program that runs under the operating system. The application program may be combined with operating system as firmware, and the application program can be updated at the same time a version of the operating system is updated. The cost for maintaining the automation device on-site can be significantly reduced by transmitting not only data, such as measurement values or machine parameters, but the complete operating system, optionally together with an additional application program, between the data processing device and the automation device. The updated operating system that is transmitted to the automation device via the network can directly replace the currently installed operating system. However, the updated operating system can also be installed on the automation device as an additional operating system, in addition to the current operating system.

According to an advantageous embodiment of the invention, the current operating system can be protected before the new operating system is installed. The original operating system can then be easily restored if the new operating system fails to operate as intended.

In the automation system, which includes the data processing device, for example a PC, as well as the automation device, the data processing device can operate as a client and the automation device can operate as a server. In principle, this arrangement can also be reversed, whereby the operating system would then have to be updated from the automation device.

Any conventional bus system, for example a PROFIBUS, can be used as a network to which the data processing device and the automation device are connected. A preferred network is, for example, the Internet or an intranet, so that the operating system can preferably be transmitted via a SSL (Secure Socket Layer)-encrypted connection. Transmission of the operating system via the Internet/intranet can be initiated via a POST command or a PUT command.

According to advantageous embodiment of the invention, transmission of the operating system via the network may require authentication of the user. Alternatively or in addition, to enhance security, the operating system can be signed, for example, with a certificate stored in one of the network servers. Security measures can also be implemented via form-based applications.

Regardless if an automation device is operated without an on-site operator or with an interactive user located on-site, the operating system, i.e., the firmware, of the automation device can be easily and safely updated, without incurring other logistic expenses, for example material, as is customary with conventional methods that use, for example, a CDROM for updating the operating system and/or other software of the automation device.

### BRIEF DESCRIPTION OF THE DRAWING

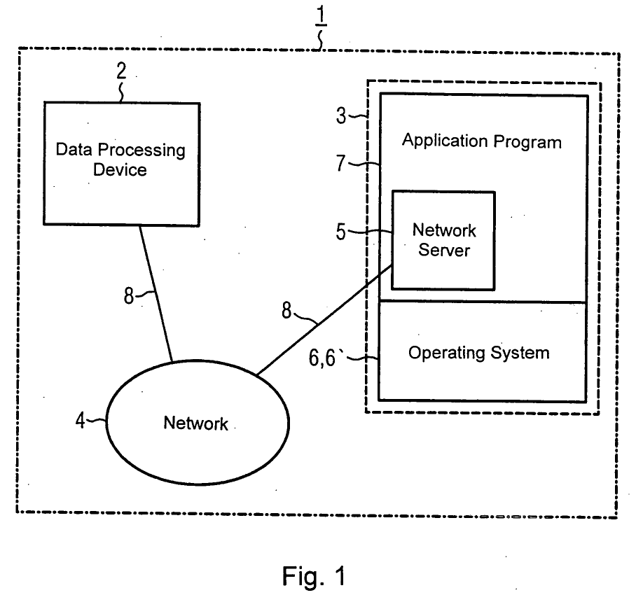

Other features and advantages of the present invention will be more readily apparent upon reading the following description of currently preferred exemplified embodiments of the invention with reference to the accompanying drawing, in which the sole FIG. 1 is a schematic block diagram of an automation system according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown an automation system 1 which includes a data processing device 2 and an automation device 3, which are connected with one another via a network 4, for example the Internet or an intranet. The data processing device 2 can be located remote from the automation device 3 and can be connected to the network 4 via wired connections 8. Alternatively or in addition, wireless connections, such as radio links, can be used instead of the wired connections 8 for communicating between the data processing device 2 and automation device 3.

The individual components of the data processing device 2, which can be, for example, a conventional PC or a larger, more complex data processing system, are not shown in detail in FIG. 1. The automation device 3, which can be used for controlling various motors, valves, etc., of one of several machines or facilities, includes a network server 5, an operating system 6 and an application program 7. The operating system 6 and the application program 7 can also be combined into a single unit, i.e., the firmware, as described above.

An updated operating system 6′ to be loaded into the automation device 3 is transmitted from the data processing device 2 via the network 4 to the automation device 3, without requiring service personnel to be present at the location of the automation device 3. The operating system 6′ can be configured to at least partially replace or extend the original operating system 6. Before the revised operating system 6′ is transmitted, the original operating system 6 is read out, for example, by transmitting the corresponding data from the automation device 3 to the data processing device 2, where the data are protected. Alternatively or in addition, the operating system 6 can also be protected on-site, i.e., directly in the automation device and/or in another device connected to the automation device 3.

The operating systems 6, 6′ and other security-related data are transmitted via https (hypertext transfer protocol secure), i.e., via a secure SSL link. Transmission via the Internet/intranet 4 is initiated either by a POST command or by a PUT command. The method for updating the data residing in the automation device 3 via a remote data link, such as the Internet/intranet 4, is particularly advantageous for facilities or machines with limited access due to space and/or safety considerations.

The security of the automation system 1 can be enhanced, for example, by requiring authentication of a user of the data processing device before executing the method, for example by entering a user name and password, and/or through biometric methods. In addition, the operating system 6, 6′ can also be signed with a certificate stored in the network server 5, so that the authenticity of the firmware, i.e., the operating system 6, 6′ or the combination of application program 7 and operating system 6, 6′, can be checked to determine, for example, if the firmware used by the automation device 3 had been obtained from a trusted source and/or has not been tampered with by an unauthorized person. The automation system 1 therefore offers a high degree of security, while simultaneously enabling convenient monitoring and updating of the automation device 3.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for updating an automation system with a data processing device and an automation device, which includes a network server, a current operating system and an application program running under the current operating system, comprising the steps of:
connecting the data processing device with the automation device via a network, and
transmitting a new operating system to the automation device via the network.

2. The method of claim 1, wherein the new operating system replaces the current operating system of the automation device.

3. The method of claim 1, wherein the current operating system is protected before the new operating system is installed.

4. The method of claim 1, wherein the data processing device operates as a client and the automation device operates as a server.

5. The method of claim 1, wherein the data processing device operates as a server and the automation device operates as a client.

6. The method of claim 1, wherein the network comprises the Internet or an intranet.

7. The method of claim 1, wherein the new operating system is transmitted via the network via a SSL-encrypted connection.

8. The method of claim 1, wherein the new operating system is transmitted via a POST command.

9. The method of claim 1, wherein the operating system is transmitted via a PUT command.

10. The method of claim 1, wherein transmission of the operating system requires authentication of the user.

11. The method of claim 1, wherein the operating system is signed with a certificate stored in the network server.
